(19) United States
(12) Patent Application Publication
(10) Pub. No.: US 2024/0078391 A1
(43) Pub. Date: Mar. 7, 2024

(54) ELECTRONIC DEVICE FOR TRAINING SPEECH RECOGNITION MODEL AND CONTROL METHOD THEREOF

(71) Applicant: SAMSUNG ELECTRONICS CO., LTD., Suwon-si (KR)

(72) Inventor: Chanwoo KIM, Suwon-si (KR)

(73) Assignee: SAMSUNG ELECTRONICS CO., LTD., Suwon-si (KR)

(21) Appl. No.: 18/225,991

(22) Filed: Jul. 25, 2023

Related U.S. Application Data
(63) Continuation of application No. PCT/KR2023/008335, filed on Jun. 16, 2023.

(30) Foreign Application Priority Data
Sep. 7, 2022 (KR) 10-2022-0113508

(51) Int. Cl. G06F 40/40

(52) U.S. Cl. CPC G06F 40/40

(57) ABSTRACT

Provided is an electronic device for training a speech recognition model and a method for controlling thereof. The method of controlling the electronic device includes obtaining a first loss value by inputting a first learning speech sequence comprising an end-of-sentence (EOS) label to the speech recognition model; and training the speech recognition model based on the first loss value. Here, the first loss value is a loss value obtained from an output of an encoder included in the speech recognition model.

### CROSS-REFERENCE TO RELATED APPLICATIONS

This application is a by-pass continuation of International Application No. PCT/KR2023/008335, filed on Jun. 16, 2023, which is based on an claims priority to Korean Patent Application No. 10-2022-0113508, filed on Sep. 7, 2022, in the Korean Patent Office, the disclosures of all of which are incorporated by reference herein in their entireties.

### BACKGROUND

### 1. Field

The disclosure relates to an electronic device for training a speech recognition model and a control method thereof and, more specifically, to an electronic device for training a speech recognition model capable of efficiently recognizing an End-Of-Sentence (EOS), and a control method thereof.

### 2. Description of Related Art

According to development of artificial intelligence (AI)-related technology, a speech recognition technology for recognizing a speech uttered by a user has been developed.

In particular, in the field of speech recognition, an electronic device should be able to recognize an end-of-sentence (EOS) to output text that is a speech recognition result to a functional block of a next operation (e.g., a natural language understanding (NLU) block for natural language understanding or a machine translation (MT) block for translation). If the EOS is detected early, the possibility of incorrect speech recognition for the rear portion of the sentence is increased, and when the EOS is detected later, latency for speech recognition becomes longer. That is, it is important to accurately detect the EOS for accurate speech recognition.

A conventional method of detecting the EOS is a method of detecting the EOS by using voice activity detection (VAD) algorithm based on signal processing. However, since only a speech signal is used and contents of a sentence are not used, there is a problem in that accuracy of EOS detection is low. In addition, it should have a significantly long buffer in order to reduce the probability of erroneous EOS detection. In this case, there is a problem that a latency for speech recognition is lengthened such that a length of a buffer is at a level of several hundreds of milliseconds.

Another conventional method is a method for detecting an EOS by training a speech recognition model by using a learning speech including an EOS label. In this case, since the speech recognition model directly senses the EOS label, a latency for speech recognition is not long. However, since there is an error rate for detecting the EOS label, there is a possibility that speech recognition for a rear portion of a sentence becomes inaccurate, since the EOS is detected, even if a sentence is not completed.

### SUMMARY

According to an aspect of the disclosure, a method of controlling an electronic device includes: obtaining a first loss value by inputting, into a speech recognition model, a first learning speech sequence including an end-of-sentence (EOS) label; and training the speech recognition model based on the first loss value, wherein the speech recognition model includes an encoder, and the first loss value is obtained from an output of the encoder.

The method of controlling an electronic device may further include: obtaining a second loss value by inputting, into the speech recognition model, a second learning speech sequence that does not include the EOS label, wherein the training may further include training the speech recognition model based on the first loss value and the second loss value, and wherein the speech recognition model may further include a decoder, and the second loss value may be obtained from an output of the decoder.

Information on a speech sequence at a time point of T outputted from the encoder, and information on a text sequence corresponding to a speech sequence of a time point of time T−1 outputted from the decoder, may be input to the decoder.

The first loss value may be a connectionist temporal classification (CTC) loss value.

The speech recognition model may include a recurrent neural network-transducer (RNN-T) model, the second loss value may be a transducer loss value, and the training may further include training the speech recognition model in a manner that results in a final loss value obtained by an equation L=L_{CTC}+L_{RNN-T} being reduced wherein L is the final loss value, L_{CTC} is a CTC loss value, and L_{RNN-T} is a transducer loss value.

The speech recognition model may include an attention-based encoder-decoder (AED) model, the second loss value may be a cross-entropy (CE) loss value, and the training may further include training the speech recognition model in a manner that results in a final loss value obtained by an equation L=L_{CTC}+L_{CE} being reduced wherein L is the final loss value, L_{CTC} is a CTC loss value, and L_{CE} is a CE loss value.

The first learning speech sequence and the second learning speech sequence may be obtained by a same learning speech.

The method of controlling an electronic device may further include: based on the first speech sequence comprising the EOS label being input to the trained speech recognition model, obtaining a second speech sequence by changing the EOS label to a preset first symbol; obtaining a text sequence by inputting the second speech sequence into the trained speech recognition model; based on the EOS label being detected from the obtained text sequence, identifying whether a token comprising a preset second symbol is output during a threshold time; and based on the token comprising the second symbol being output during the threshold time, outputting the obtained text sequence by recognizing the detected EOS label.

The method of controlling an electronic device may further include: based on a token comprising a text symbol being output during the threshold time, ignoring the detected EOS label.

According to as aspect of the disclosure, an electronic device includes: at least one memory storing speech recognition model data; and at least one processor configured to access the speech recognition model data and to: obtain a first loss value by inputting, into a speech recognition model, a first learning speech sequence comprising an end-of-sentence (EOS) label, and train the speech recognition model based on the first loss value, wherein the speech recognition model includes an encoder, and the first loss value is obtained from an output of the encoder.

The at least one processor of the electronic device may be further configured to: obtain a second loss value by inputting, into the speech recognition model, a second learning speech sequence that does not include the EOS label, and train the speech recognition model based on the first loss value and the second loss value, wherein the speech recognition model further may include a decoder, and the second loss value is obtained from an output of the decoder.

Information on a speech sequence at a time point of T outputted from the encoder, and information on a text sequence corresponding to a speech sequence of a time point of time T−1 outputted from the decoder, may be input to the decoder.

The first loss value may be a connectionist temporal classification (CTC) loss value.

The speech recognition model may include a recurrent neural network-transducer (RNN-T) model, the second loss value may be a transducer loss value, and the at least one processor of the electronic device may be further configured to train the speech recognition model in a manner that results in a final loss value obtained by an equation L=L_{CTC}+L_{RNN-T} being reduced, wherein L is the final loss value, L_{CTC} is a CTC loss value, and L_{RNN-T} is a transducer loss value.

The speech recognition model may include an attention-based encoder-decoder (AED) model, the second loss value may be a cross-entropy (CE) loss value, and the at least one processor of the electronic device may be further configured to train the speech recognition model in a manner that results in a final loss value obtained by the equation L=L_{CTC}+L_{CE} being reduced, wherein L is the final loss value, L_{CTC} is a CTC loss value, and L_{CE} is a CE loss value.

According to an aspect of the disclosure, a non-transitory computer readable medium including instructions stored therein, which when executed by at least one processor cause the at least one processor to execute a method of controlling an electronic device, the method including: obtaining a first loss value by inputting, into a speech recognition model, a first learning speech sequence including an end-of-sentence (EOS) label; obtaining a second loss value by inputting, into the speech recognition model, a second learning speech sequence that does not include the EOS label; training the speech recognition model based on the first loss value and the second loss value; wherein the speech recognition model includes an encoder and a decoder, the first loss value is obtained from an output of the encoder, and the second loss value is obtained from an output of the decoder.

Information on a speech sequence at a time point of T outputted from the encoder, and information on a text sequence corresponding to a speech sequence of a time point of time T−1 outputted from the decoder, may be input to the decoder.

The speech recognition model may include a recurrent neural network-transducer (RNN-T) model, the first loss value is a connectionist temporal classification (CTC) loss value and the second loss value may be a transducer loss value, and the training may further include training the speech recognition model in a manner that results in a final loss value obtained by an equation L=L_{CTC}+L_{RNN-T} being reduced, wherein L is the final loss value, L_{CTC} is a CTC loss value, and L_{RNN-T} is a transducer loss value.

The speech recognition model may include an attention-based encoder-decoder (AED) model, the first loss value may be a connectionist temporal classification (CTC) loss value and the second loss value may be a cross-entropy (CE) loss value, and the training may further include training the speech recognition model in a manner that results in a final loss value obtained by an equation L=L_{CTC}+L_{CE} being reduced, wherein L is the final loss value, L_{CTC} is a CTC loss value, and L_{CE} is a CE loss value.

The non-transitory computer readable medium, wherein the method may further include: based on the first speech sequence comprising the EOS label being input to the trained speech recognition model, obtaining a second speech sequence by changing the EOS label to a preset first symbol; obtaining a text sequence by inputting the second speech sequence into the trained speech recognition model; based on the EOS label being detected from the obtained text sequence, identifying whether a token comprising a preset second symbol is output during a threshold time; and based on the token comprising the second symbol being output during the threshold time, outputting the obtained text sequence by recognizing the detected EOS label.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to one or more embodiments of the disclosure;

FIG. 2 is a diagram for briefly describing a speech recognition model according to one or more embodiments of the disclosure;

FIGS. 3 and 4 are diagrams for describing a method for training an RNN-T model according to one or more embodiments of the disclosure;

FIGS. 5 and 6 are diagrams for describing a method for training an AED model according to one or more embodiments of the disclosure;

FIG. 7 is a flowchart for describing a control method of an electronic device for training a speech recognition model, according to an embodiment of the disclosure; and

FIG. 8 is a flowchart for describing a method for performing speech recognition by inserting a preset symbol instead of an EOS label into a trained speech recognition model, according to one or more embodiments of the disclosure.

### DETAILED DESCRIPTION

The disclosure includes various embodiments, some of which are illustrated in the drawings and described in detail in the detailed description. However, this disclosure is not intended to limit the embodiments described herein but includes various modifications, equivalents, and/or alternatives. In the context of the description of the drawings, like reference numerals may be used for similar components.

In describing the disclosure, a detailed description of known functions or configurations incorporated herein will be omitted as it may make the subject matter of the disclosure unclear.

In addition, the embodiments described below may be modified in various different forms, and the scope of the technical concept of the disclosure is not limited to the following embodiments. Rather, these embodiments are provided so that this disclosure will be thorough and complete, and will fully convey the scope of the disclosure to those skilled in the art.

The terms used in this disclosure are used merely to describe a particular embodiment, and are not intended to limit the scope of the claims. The expression of a singular includes a plurality of representations, unless the context clearly indicates otherwise.

In this document, the expressions “have,” “may have,” “including,” or “may include” may be used to denote the presence of a feature (e.g., a component, such as a numerical value, a function, an operation, a part, or the like), and does not exclude the presence of additional features.

The expressions “A or B,” “at least one of A and/or B,” or “one or more of A and/or B,” and the like include all possible combinations of the listed items. For example, “A or B,” “at least one of A and B,” and “at least one of A or B” all include: (1) at least one of A, (2) at least one of B, and (3) at least one of A and at least one of B.

In addition, expressions “first”, “second”, or the like, used in the disclosure may indicate various components regardless of a sequence and/or importance of the components, will be used only in order to distinguish one component from the other components, and do not limit the corresponding components.

It is to be understood that an element (e.g., a first element) is “operatively or communicatively coupled with/to” another element (e.g., a second element) is that any such element may be directly connected to the other element or may be connected via another element (e.g., a third element).

On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of” The expression “configured to” does not necessarily mean “specifically designed to” in a hardware sense.

Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

The terms such as “module,” “unit,” “part”, and so on are used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

The various elements and regions in the drawings are schematically drawn. Accordingly, the technical spirit of the disclosure is not limited by the relative size or spacing depicted in the accompanying drawings.

Embodiments of the disclosure will now be described in detail with reference to the attached drawings so that those skilled in the art can easily implement the embodiment.

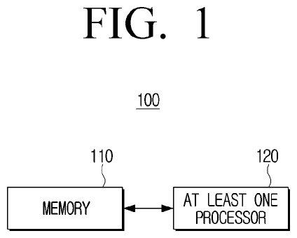

FIG. 1 is a block diagram briefly illustrating a configuration of the electronic device 100 according to one or more embodiments of the disclosure. The electronic device 100 according to the disclosure is a device capable of training a speech recognition model capable of obtaining a text sequence corresponding to a speech sequence by inputting a speech sequence corresponding to a user speech. For example, the electronic device 100 may be a device such as a server, but may be a user terminal such as a smartphone, a tablet personal computer (PC), or the like.

As shown in FIG. 1, the electronic device 100 according to one or more embodiments of the disclosure may include a memory 110 and at least one processor 120. However, the configuration shown in FIG. 1 is merely an embodiment, and other configurations may be added according to the type of the electronic device 100. For example, when the electronic device 100 is implemented as a server, the electronic device 100 may further include a communication interface for obtaining learning data (for example, a learning speech sequence, a learning speech signal, etc.), and when the electronic device 100 is implemented as a user terminal, the electronic device 100 may further include a communication interface for obtaining learning data, an input interface (for example, a microphone), and the like.

The memory 110 may store at least one instruction for controlling the electronic device 100. The memory 110 may store an operating system (OS) for driving the electronic device 100. In addition, various software programs or applications for operating the electronic device 100 may be stored in the memory 110 according to various embodiments of the disclosure. The memory 110 may include a semiconductor memory such as a flash memory or a magnetic storage medium such as a hard disk.

Specifically, the memory 110 may store various software modules for operating the electronic device 100 according to various embodiments of the disclosure, and the at least one processor 120 may control the operation of the electronic device 100 by executing various software modules stored in the memory 110. That is, the memory 110 may be accessed by at least one processor 120, and reading/writing/correcting/deleting/updating of data by the processor 130 may be performed.

The term memory 110 may be used to denote the memory 110, a ROM, a RAM in the processor 120, a memory card mounted to the electronic apparatus 100 (for example, a micro SD card or a memory stick).

In particular, in various embodiments according to the disclosure, data for a speech recognition model may be stored in the memory 110. Here, the data for the speech recognition model may include information on weights, various parameters, and nodes constituting the neural network included in the speech recognition model, and may include learning data for training (or learning) the speech recognition model, input/output data for the speech recognition model, input/output data of modules included in the speech recognition model, and the like. In addition, the memory 110 may store information about a speech signal and a speech sequence corresponding to the user speech and information on a text sequence corresponding to the speech sequence.

Various information required within a range for achieving the purpose of the disclosure may be stored in the memory 110, and the information stored in the memory 110 may be received from an external device or may be updated as input by a user.

At least one processor 120 controls the overall operation of the electronic device 100. Specifically, the at least one processor 120 is connected to the configuration of the electronic device 100 including the memory 110, and executes at least one instruction stored in the memory 110 as described above to control the overall operation of the electronic device 100.

At least one processor 120 may train a speech recognition model capable of obtaining a text sequence corresponding to a speech sequence by inputting a speech sequence corresponding to a user speech. Particularly, in an embodiment of the disclosure, at least one processor 120 obtains a first loss value by inputting a first learning speech sequence including the EOS label to a speech recognition model. The at least one processor 120 may train the speech recognition model based on the first loss value. The first loss value may be a loss value obtained from an output of an encoder included in a speech recognition model.

Here, the “speech recognition model” refers to a neural network model trained to obtain text data corresponding to a user speech by recognizing a user speech. In particular, the speech recognition model according to the disclosure may be configured to perform speech recognition on a predetermined language. The speech recognition model may be referred to as an automatic speech recognition (ASR) model. In particular, the speech recognition model may be an end-to-end speech recognition model that directly predicts a text sequence (e.g., a phoneme sequence, a word sequence, etc.) corresponding to an input speech sequence.

The term “speech sequence” is used as a term for specifying a set of sequentially received speech signals when a user's speech by the user's utterance is sequentially received in the form of a speech signal through an input means (e.g., a microphone). The speech sequence may be a speech pre-processing (e.g., noise removal, time-frequency conversion, etc.).

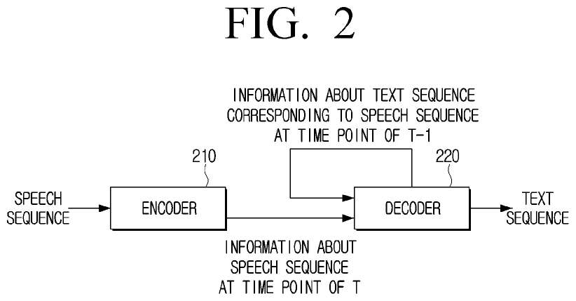

FIG. 2 is a diagram schematically illustrating a speech recognition model according to one or more embodiments of the disclosure. Specifically, a speech recognition model according to one or more embodiments of the disclosure may be a sequence-to-sequence model including an encoder 210 for obtaining information (for example, a hidden vector) corresponding to a speech sequence and a decoder 220 for obtaining a text sequence based on information corresponding to the speech sequence.

In particular, the speech recognition model may be a recurrent speech recognition model in which information about a speech sequence at a time point of time T output from the encoder 210 and information on a text sequence corresponding to a speech sequence at a time point of time T−1 output from the decoder 220 are input to the decoder 220. For example, the speech recognition model may be implemented as a recurrent neural network-transducer (RNN-T) model or an attention-based encoder-decoder (AED) model, but this is merely an embodiment, and may be implemented as another recurrent speech recognition model.

Specifically, the encoder 210 may be trained based on learning data composed of a preset language (for example, English or Korean, etc.), and may be trained to output information (for example, a hidden vector corresponding to a speech sequence) corresponding to an input speech sequence. The encoder 210 may include a plurality of layers for obtaining a hidden vector corresponding to the speech sequence. In this case, the layer may be implemented as a long short-term memory (LSTM). However, this is merely an embodiment, and may be implemented by gated recurrent units (GRU), a conformer, a convolutional neural network (CNN), a transformer, and the like.

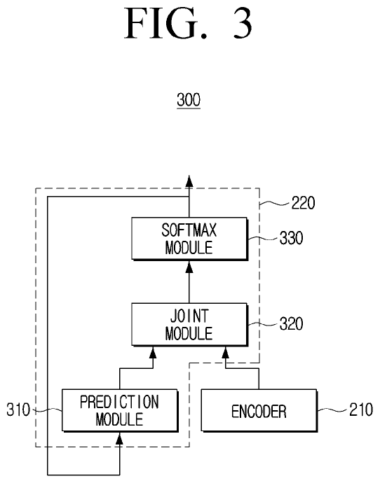

The decoder 220 may output a text sequence corresponding to the speech sequence at the current time point based on the information obtained from the encoder 210 at the time point T (or the current time point) and the information obtained from the decoder 220 at the time point T−1 (previous time point). The decoder 220 may include various types of modules according to the type of speech recognition. This will be described with reference to FIGS. 3 to 6.

In the meantime, when learning the speech recognition model, the learning data is configured in units of sentences. The learning data may include not only a learning speech sequence but also an EOS label (for example, </S>). However, the conventional learning database does not have a different word after the EOS label comes out. Of course, a plurality of sentences may be subsequently trained, but in this case, there is a problem that a lot of memory is required to train speech recognition and a batch size becomes small, and thus there is a problem in that a lot of training time is needed. Therefore, since the speech recognition model is not trained by using training data in which a word comes out after the EOS label, when a word comes out after the EOS label in an inference operation, there is a problem in that speech recognition performance is very deteriorated.

Particularly, when information on a text sequence at a previous time point outputted from the decoder 220 is re-inputted to the decoder 220 again in order to obtain a text sequence at a current time point, such as the RNN-T model or an AED model, there is a problem in that information including the EOS label at a previous time point is again inputted to the decoder. In this case, there is a problem in that performance of speech recognition is degraded.

According to one or more embodiments of the disclosure, at least one processor 120 may obtain a first loss value by inputting a first learning speech sequence including an EOS label to a speech recognition model. The first loss value is a loss value obtained from an output of the encoder 210 included in a speech recognition model, and may be a connectionist temporal classification (CTC) loss value. At this time, the CTC loss value may be a loss value used in a learning method of a speech recognition model capable of obtaining a text sequence by inputting a speech sequence without explicit alignment information between an input speech sequence and a text sequence. The at least one processor 120 may train the speech recognition model based on the first loss value.

More specifically, the at least one processor 120 may obtain a first loss value by inputting a first learning speech sequence including the EOS label to a speech recognition model, and obtain a second loss value by inputting a second learning speech sequence that does not include the EOS label in the speech recognition model. The second loss value may be a loss value obtained from an output of the decoder 220 included in the speech recognition model. Here, the second loss value may be different according to the type of the speech recognition model. For example, in the case of an RNN-T model, a second loss value may be a transducer loss value, and in the case of an AED model, a second loss value may be a cross-entropy (CE) loss value. The first learning speech sequence and the second learning speech sequence may be obtained by the same learning speech.

At least one processor 120 may train a speech recognition model based on a first loss value and a second loss value. Specifically, when a speech recognition model is an RNN-T model, at least one processor 120 may train a speech recognition model such that a final loss value obtained by Equation 1 below is reduced.

L=L_{CTC}+L_{RNN-T} Equation 1:

In Equation 1, L is a final loss value, L_{CTC} is a CTC loss value, and L_{RNN-T} is a transducer loss value.

Or, if the speech recognition model is an AED model, at least one processor 120 may train a speech recognition model such that the final loss value obtained by Equation 2 below is reduced.

L=L_{CTC}+L_{CE} Equation 2:

In Equation 2, L is a final loss value, L_{CTC} is a CTC loss value, and L_{CE} is a CE loss value.

As described above, when learning a recurrent speech recognition model, learning data including an EOS label is input to a speech recognition model to train a speech recognition model based on a loss value obtained from an output of the encoder 210, so that information including the EOS label is not inputted to the decoder 220, thereby improving the performance of the speech recognition model.

Hereinbelow, a method of learning a speech recognition model according to various embodiments of the disclosure will be described with reference to FIGS. 3 to 6.

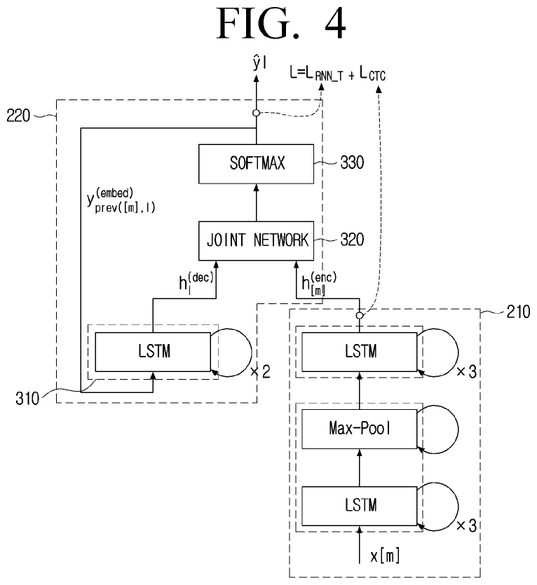

FIGS. 3 and 4 are diagrams for describing a method for training an RNN-T model according to one or more embodiments of the disclosure.

An RNN-T model 300 may include the encoder 210, and the decoder 220, where the decoder 220 includes a prediction module 310, a joint module 320, and a softmax module 330, as shown in FIG. 3.

The encoder 210 may include a plurality of layers, as shown in FIG. 4. In particular, the encoder 210 may obtain a hidden vector corresponding to the speech sequence input through a plurality of layers. In this case, the plurality of layers included in the encoder 210 may be implemented as long short-term memory (LSTM) and max-pool, as shown in FIG. 4, but this is only an exemplary embodiment, and the encoder 210 may be implemented as Gated Recurrent Units (GRU), conformer, Convolutional Neural Network (CNN), transformer, and the like.

In particular, the encoder 210 may further include a softmax module for obtaining a CTC loss value (L_{CTC}) at the output. Therefore, when the speech recognition model is trained, the electronic device 100 may input a learning speech sequence including the EOS label to obtain a CTC loss value (L_{CTC}) at an output of the encoder 210.

A prediction module 310 of the decoder 220 may include at least one layer, and may convert a text sequence of a t−1 time point (or a previous time point) into a hidden vector and output the hidden vector. For example, when a speech sequence of a t time point (or a current time point) is converted into a first hidden vector by an encoder 210 and outputted, the prediction module 340 may convert a text sequence at a t−1 time point into a second hidden vector and output the second hidden vector. Here, the term “first hidden vector” and “second hidden vector” are used as terms for distinguishing and specifying a hidden vector output through the encoder 210 and a hidden vector output through the prediction module 310. The term prediction module 310 may be replaced with the term “prediction network module”. Here, the prediction module 310 may include at least one layer. The at least one layer may be implemented as an LSTM, as shown in FIG. 4, but is not limited thereto.

A joint module 320 of the decoder 220 may output a logit vector corresponding to a speech sequence of a t time point based on a hidden vector output through the encoder 210 and a hidden vector output through the prediction module 310. For example, when a first hidden vector is output through the encoder 210 and a second hidden vector is output through the prediction module 310, the joint module 320 may output a logit vector corresponding to a speech sequence at a time point t based on the first hidden vector and the second hidden vector. The term joint module 320 may be replaced with the term “joint network module”.

A softmax module 330 of the decoder 220 may output a text sequence corresponding to a speech sequence at a t time point based on an input logit vector. Specifically, the softmax module 330 may identify a class corresponding to a speech sequence at a current time point from among a plurality of classes by normalizing an input logit vector to a value between 0 and 1, and output a text sequence corresponding to the speech sequence according to the identification result.

In particular, when learning a speech recognition model, the electronic device 100 may obtain a transducer loss value (L_{RNN_T}) at an output of the decoder 220 by inputting a learning speech sequence that does not include an EOS label.

When learning the speech recognition model, the electronic device 100 may obtain a final loss value based on the CTC loss value obtained at the output of the encoder 210 and the transducer loss value obtained at the output of the decoder 220. For example, the electronic device 100 may train a speech recognition model to reduce a final loss value obtained by Equation 1. As another example, the electronic device 100 may train a speech recognition model so that a final loss value obtained by Equation 3 below is reduced.

L=βL_{CTC}+(1−β)L_{RNN-T} Equation 3:

In Equation 3, L may be a final loss value, L_{CTC} may be a CTC loss value, L_{RNN-T} may be a transducer loss value, and β may be a parameter between 0 and 1.

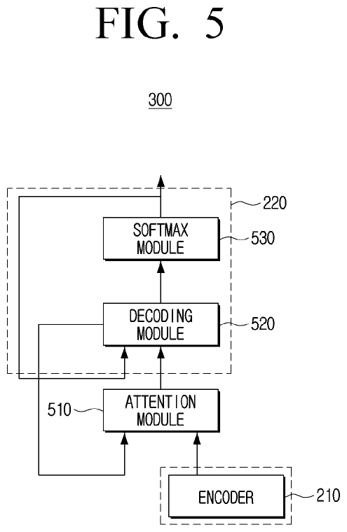

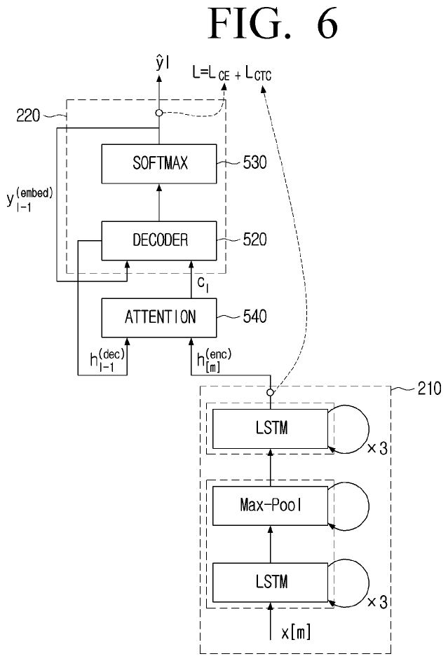

FIGS. 5 and 6 are diagrams for describing a method for training an AED model according to one or more embodiments of the disclosure.

As illustrated in FIG. 5, the AED model may include the encoder 210, an attention module 510 and the decoder 220, wherein the decoder 220 includes a decoding module 520, and a softmax module 530.

The encoder 210 may obtain a hidden vector corresponding to a speech sequence inputted through a plurality of layers. Here, as shown in FIG. 6, the plurality of layers included in the encoder 210 may be implemented as a long short-term memory (LSTM) and a Max-pool, but this is merely an exemplary embodiment, and the encoder 210 may be implemented by other types of layers.

In particular, the encoder 210 may further include a softmax module for obtaining a CTC loss value (L_{CTC}) at an output. Therefore, when the speech recognition model is trained, the electronic device 100 may input a learning speech sequence including an EOS label to obtain a CTC loss value (L_{CTC}) at an output of the encoder 210.

The attention module 510 may obtain attention information (for example, a convex vector) based on a hidden vector at a t time point obtained through the encoder 210 and a hidden vector at a t−1 time point by a decoding module 520. An attention module 510 may output attention information to a decoding module 520.

The decoding module 520 may output a logit vector corresponding to a speech sequence of a t time point based on attention information obtained at a t time point and a hidden vector obtained at t−1 time point.

The softmax module 530 may output a text sequence corresponding to a speech sequence at a t−1 time point based on an input logit vector. Specifically, the softmax module 530 may identify a class corresponding to a speech sequence at a current time point from among a plurality of classes by normalizing an input logit vector to a value between 0 and 1, and output a text sequence corresponding to the speech sequence according to the identification result.

In particular, when learning a speech recognition model, the electronic device 100 may obtain a CE loss value (L_{CE}) at an output of the decoder 220 by inputting a learning speech sequence that does not include the EOS label.

When the speech recognition model is trained, the electronic device 100 may obtain a final loss value based on the CTC loss value obtained from the output of the encoder 210 and the CE loss value obtained at the output of the decoder 220. For example, the electronic device 100 may train a speech recognition model to reduce a final loss value obtained by Equation 2. As another example, the electronic device 100 may train a speech recognition model so that a final loss value obtained by Equation 4 below is reduced.

L=βL_{CTC}±(1−β)L_{CE} Equation 4:

In Equation 4, L may be a final loss value, L_{CTC} may be a CTC loss value, L_{CE} may be a CE loss value, and β may be a parameter between 0 and 1.

As described above, when learning a recurrent speech recognition model, such as the RNN-T model or the AED model, learning data including an EOS label may be input to a speech recognition model to train a speech recognition model based on a loss value obtained at an output of the encoder 210 rather than an output of the decoder 220, so that information including the EOS label is not inputted again to the decoder 220, thereby improving the performance of the speech recognition model.

In the meantime, although it has been described that the technical idea of the disclosure is applied to a speech recognition model for outputting a user speech as text, this is merely an embodiment, and the technical idea of the disclosure may also be applied to a speech-to-translated text model which converts a user speech of a first language into a text translated in a second language and outputs the converted text, and a speech-to-speech translation model which converts a user speech of a first language into a speech of a second language and outputs the converted text. That is, a speech-to-translated text model or a speech-to-speech translation model may be trained based on a first loss value obtained by inputting first learning data including an EOS symbol to a speech-to-translated text model or a speech-to-speech translation model, or a second loss value obtained by inputting second learning data not including the EOS symbol to a speech-to-speech translation model. At this time, a first loss value may be obtained at an output of an encoder of a speech-to-translated text model or a speech-to-speech translation model, and a second loss value may be obtained at an output of a decoder of a speech-to-translated text model or a speech-to-speech translation model.

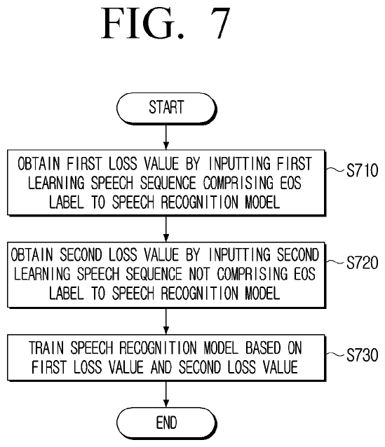

FIG. 7 is a flowchart for describing a control method of an electronic device for training a speech recognition model, according to an embodiment of the disclosure. The speech recognition model may be a speech recognition model in which information on a speech sequence at a time point of T outputted from the encoder and information on a text sequence corresponding to a speech sequence of a time point of time T−1 outputted from the decoder are input to the decoder.

The electronic device 100 obtains a first loss value by inputting a first learning speech sequence comprising an end-of-sentence (EOS) label to the speech recognition model in operation S710. At this time, the first loss value is a loss value obtained from an output of an encoder included in the speech recognition model and may be a CTC loss value.

The electronic device 100 may obtain a second loss value by inputting a second learning speech sequence not including the EOS label to the speech recognition model in operation S720. The second loss value may be a loss value obtained from an output of the decoder included in the speech recognition model. For example, when the speech recognition model is an RNN-T model, the second loss value may be a transducer loss value, and when the speech recognition model is an AED model, the second loss value may be a CE loss value.

The electronic device 100 may train a speech recognition model based on a first loss value and a second loss value in operation S730. Specifically, when the speech recognition model is an RNN-T model, the electronic device 100 may obtain a final loss value based on a CTC loss value obtained from an output of the encoder and a transducer loss value obtained from an output of the decoder. In addition, the electronic device 100 may train the RNN-T model such that the obtained final loss value is reduced. When the speech recognition model is an AED model, the electronic device 100 may obtain a final loss value based on the CTC loss value obtained from the output of the encoder and the CE loss value obtained from the output of the decoder. In addition, the electronic device 100 may train the AED model so that the obtained final loss value is reduced.

As described above, a speech recognition model capable of better sensing the EOS may be provided by training the speech recognition model based on a loss value obtained at the output of the encoder and a loss value obtained at the output of the decoder through learning data including the EOS label in the learning operation.

In the meantime, the EOS may be detected better by using a method shown below even in the inference operation, not the learning operation.

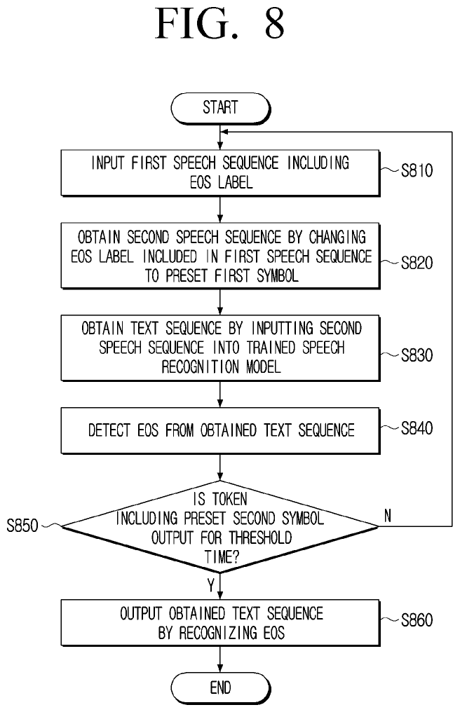

FIG. 8 is a flowchart for describing a method for performing speech recognition by inserting a preset symbol instead of an EOS label into a trained speech recognition model, according to one or more embodiments of the disclosure.

First, the electronic device 100 may receive a first speech sequence including an EOS label in operation S810. For example, the electronic device 100 may receive a first speech sequence including an EOS label (for example, </S?>) at the end of a speech sequence.

In addition, the electronic device 100 may obtain a second speech sequence by changing the EOS label included in the first speech sequence to a preset first symbol in operation S820. That is, the electronic device 100 may input the second speech sequence by changing the EOS label included in the first speech sequence to a blank symbol (for example, <b>) or a silent symbol (for example, <s>) before inputting the first speech sequence to the encoder.

The electronic device 100 may obtain a text sequence by inputting a second voice sequence into a trained voice recognition model in operation S830. For example, the electronic device 100 may obtain a text sequence by inputting a second voice sequence to the RNN-T model or the AED model described with reference to FIGS. 1 to 7. However, the RNN-T model or the AED model is merely an exemplary embodiment, and a second voice sequence may be input to another voice recognition model.

The electronic device 100 may detect the EOS from the obtained text sequence in operation S840.

When an EOS is detected from the obtained text sequence, the electronic device 100 may determine whether a token including a preset second symbol is output for a threshold time in operation S850. At this time, the preset second symbol may include a blank symbol (e.g., <b>) or a silent symbol (for example, <s>) and a noise symbol (for example, <NOISE>). That is, if only a preset second symbol is output within a threshold time (for example, 0.5 seconds) after the EOS is detected, the electronic device 100 may determine the detected EOS as an accurate EOS.

When a token including a second symbol is output for a threshold time in operation S850-Y, the electronic device 100 may recognize the EOS and output the obtained text sequence in operation S860. Specifically, if an accurate EOS is recognized, the electronic device 100 may output information on the obtained text sequence as a next functional block (e.g., a natural language understanding (NLU) block for natural language understanding or a machine translation (MT) block for translation).

Based on a token comprising a text symbol being output during the threshold time in operation S860-N, the electronic device 100 may ignore the detected EOS, and may perform speech recognition based on the speech sequence of the next time point again.

The function related to artificial intelligence according to the disclosure operates through the processor and the memory of the electronic device 100.

The processor may be composed of one or a plurality of processors. The one or a plurality of processors may include at least one of a central processing unit (CPU), a graphics processing unit (GPU), and a neural processing unit (NPU) but is not limited to the aforementioned example of the processor.

The CPU is a general-use processor capable of performing AI calculation in addition to general calculation and may efficiently execute a complicated program through multilayer cache structure. The CPU is advantageous for serial processing capable of organic association between previous calculation result and the next calculation result through sequential calculation. The general-use processor is not limited to the aforementioned example excluding a case of limiting to a CPU described above.

The GPU is a processor for mass operation such as floating point calculation used for graphic processing and may perform large-capacity operation (mass operation) in parallel by integrating core in large capacity. Particularly, GPU may be advantageous in parallel processing such as convolution calculation as compared to CPU. In addition, GPU may be used as a co-processor to supplement a function of the CPU. The processor for mass operation is not limited to the above example except when the processor is specified as the GPU described above.

The NPU is a processor specialized for AI operation using AI neural network and may implement each layer composing the AI neural network as hardware (e.g., silicon). Since the NPU is designed to be specialized according to a requirement specification of the company, the degree of freedom is lower than that of a CPU or a GPU, but an artificial intelligence operation for requesting a company may be efficiently processed. Meanwhile, a processor specialized for artificial intelligence calculation may be implemented in various forms such as a Tensor Processing Unit (TPU), an Intelligent Processing Unit (IPU), and a Vision Processing Unit (VPU). The artificial intelligence processor is not limited to the above-described example, except for a case where it is specified as the NPU described above.

The one or more processors may also be implemented with a System on Chip (SoC). The SoC may further include, in addition to the one or more processors, a memory, a processor, and a network interface such as a bus for data communication between the processor and the memory.

When a plurality of processors are included in the SoC included in the electronic device, the electronic device may perform an operation related to artificial intelligence (for example, an operation related to learning or inference of an artificial intelligence model) by using some of the plurality of processors. For example, the electronic device may perform an operation related to artificial intelligence by using at least one of a GPU, an NPU, a VPU, a TPU, and a hardware accelerator specialized for an artificial intelligence operation such as a convolution operation, a matrix multiplication operation, and the like among a plurality of processors. However, this is merely an exemplary embodiment, and an operation related to artificial intelligence may be processed by using a CPU and a general-purpose processor.

In addition, the electronic device may perform an operation on a function related to artificial intelligence by using a multi-core (for example, a dual core, a quad core, etc.) included in one processor. In particular, the electronic device may perform an artificial intelligence operation such as a convolution operation and a matrix multiplication operation in parallel using a multi-core included in the processor.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has at least one weight value, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause the target device to make a determination or prediction by itself. Examples of learning algorithms include, but are not limited to, supervised learning, unsupervised learning, semi-supervised learning, or reinforcement learning.

According to an embodiment, the method according to the above-described embodiments may be provided as being included in a computer program product. The computer program product may be traded as a product between a seller and a consumer. The computer program product may be distributed online in the form of machine-readable storage media (e.g., compact disc read only memory (CD-ROM)) or through an application store (e.g., Play Store™ and App Storey™) or distributed online (e.g., downloaded or uploaded) directly between to users (e.g., smartphones). In the case of online distribution, at least a portion of the computer program product may be at least temporarily stored or temporarily generated in a server of the manufacturer, a server of the application store, or a machine-readable storage medium such as memory of a relay serve.

The various embodiments described above may be implemented as software including instructions stored in a machine-readable storage media which is readable by a machine (e.g., a computer). The device may include the electronic device (e.g., TV) according to the disclosed embodiments, as a device which calls the stored instructions from the storage media and which is operable according to the called instructions.

A machine-readable storage medium may be provided in the form of a non-transitory storage medium. Herein, the term “non-transitory” only denotes that a storage medium does not include a signal (e.g., electromagnetic waves) but is tangible, and does not distinguish the case in which a data is semi-permanently stored in a storage medium from the case in which a data is temporarily stored in a storage medium. For example, “non-transitory storage medium” may refer to a buffer temporarily storing data.

When the instructions are executed by a processor, the processor may directory perform functions corresponding to the instructions using other components or the functions may be performed under a control of the processor. The instructions may include code generated or executed by a compiler or an interpreter.

While example embodiments of the disclosure have been illustrated and described, the disclosure is not limited to the specific embodiments described above. It will be understood by those skilled in the art that various changes in form and details may be made therein without departing from the true spirit and full scope of the disclosure, including the appended claims and their equivalents.

What is claimed is:

1. A method of controlling an electronic device, the method comprising:
obtaining a first loss value by inputting, into a speech recognition model, a first learning speech sequence comprising an end-of-sentence (EOS) label; and
training the speech recognition model based on the first loss value,
wherein the speech recognition model comprises an encoder, and the first loss value is obtained from an output of the encoder.

2. The method of claim 1, further comprising:
obtaining a second loss value by inputting, into the speech recognition model, a second learning speech sequence that does not include the EOS label,
wherein the training further comprises training the speech recognition model based on the first loss value and the second loss value, and
wherein the speech recognition model further comprises a decoder, and the second loss value is obtained from an output of the decoder.

3. The method of claim 2, wherein information on a speech sequence at a time point of T outputted from the encoder and information on a text sequence corresponding to a speech sequence of a time point of time T−1 outputted from the decoder are input to the decoder.

4. The method of claim 3, wherein the first loss value is a connectionist temporal classification (CTC) loss value.

5. The method of claim 4,
wherein the speech recognition model comprises a recurrent neural network-transducer (RNN-T) model,
wherein the second loss value is a transducer loss value,
wherein the training further comprises training the speech recognition model in a manner that results in a final loss value obtained by an equation L=L_{CTC} L_{RNN-T} being reduced, and
wherein L is the final loss value, L_{CTC} is a CTC loss value, and L_{RNN-T} is a transducer loss value.

6. The method of claim 4, wherein the speech recognition model comprises an attention-based encoder-decoder (AED) model,
wherein the second loss value is a cross-entropy (CE) loss value,
wherein the training further comprises training the speech recognition model in a manner that results in a final loss value obtained by an equation L=L_{CTC} L_{CE} being reduced, and
wherein L is the final loss value, L_{CTC} is a CTC loss value, and L_{CE} is a CE loss value.

7. The method of claim 2, wherein the first learning speech sequence and the second learning speech sequence are obtained by a same learning speech.

8. The method of claim 1, further comprising:
based on the first speech sequence comprising the EOS label being input to the trained speech recognition model, obtaining a second speech sequence by changing the EOS label to a preset first symbol;
obtaining a text sequence by inputting the second speech sequence into the trained speech recognition model;
based on the EOS label being detected from the obtained text sequence, identifying whether a token comprising a preset second symbol is output during a threshold time; and
based on the token comprising the second symbol being output during the threshold time, outputting the obtained text sequence by recognizing the detected EOS label.

9. The method of claim 8, further comprising:
based on a token comprising a text symbol being output during the threshold time, ignoring the detected EOS label.

10. An electronic device comprising:
at least one memory storing speech recognition model data; and
at least one processor configured to access the speech recognition model data and to:
obtain a first loss value by inputting, into a speech recognition model, a first learning speech sequence comprising an end-of-sentence (EOS) label, and
train the speech recognition model based on the first loss value,
wherein the speech recognition model comprises an encoder, and the first loss value is obtained from an output of the encoder.

11. The electronic device of claim 10, wherein the at least one processor is further configured to:
obtain a second loss value by inputting, into the speech recognition model, a second learning speech sequence that does not include the EOS label, and
train the speech recognition model based on the first loss value and the second loss value,
wherein the speech recognition model further comprises a decoder, and the second loss value is obtained from an output of the decoder.

12. The electronic device of claim 11, wherein information on a speech sequence at a time point of T outputted from the encoder and information on a text sequence corresponding to a speech sequence of a time point of time T−1 outputted from the decoder are input to the decoder.

13. The electronic device of claim 12, wherein the first loss value is a connectionist temporal classification (CTC) loss value.

14. The electronic device of claim 13,
wherein the speech recognition model comprises a recurrent neural network-transducer (RNN-T) model,
wherein the second loss value is a transducer loss value,
wherein the at least one processor is further configured to train the speech recognition model in a manner that results in a final loss value obtained by an equation L=L_{CTC} L_{RNN-T} being reduced, and
wherein L is the final loss value, L_{CTC} is a CTC loss value, and L_{RNN-T} is a transducer loss value.

15. The electronic device of claim 13,
wherein the speech recognition model comprises an attention-based encoder-decoder (AED) model,
wherein the second loss value is a cross-entropy (CE) loss value,
wherein the at least one processor is further configured to train the speech recognition model in a manner that results in a final loss value obtained by the equation L=L_{CTC}+L_{CE} being reduced, and
wherein L is the final loss value, L_{CTC} is a CTC loss value, and L_{CE} is a CE loss value.

16. A non-transitory computer readable medium having instructions stored therein, which when executed by at least one processor cause the at least one processor to execute a method of controlling an electronic device, the method comprising:
obtaining a first loss value by inputting, into a speech recognition model, a first learning speech sequence comprising an end-of-sentence (EOS) label;
obtaining a second loss value by inputting, into the speech recognition model, a second learning speech sequence that does not include the EOS label; and
training the speech recognition model based on the first loss value and the second loss value,
wherein the speech recognition model comprises an encoder and a decoder, the first loss value is obtained from an output of the encoder, and the second loss value is obtained from an output of the decoder.

17. The non-transitory computer readable medium of claim 16, wherein information on a speech sequence at a time point of T outputted from the encoder and information on a text sequence corresponding to a speech sequence of a time point of time T−1 outputted from the decoder are input to the decoder.

18. The non-transitory computer readable medium of claim 17,
wherein the speech recognition model comprises a recurrent neural network-transducer (RNN-T) model,
wherein the first loss value is a connectionist temporal classification (CTC) loss value and the second loss value is a transducer loss value,
wherein the training further comprises training the speech recognition model in a manner that results in a final loss value obtained by an equation L=L_{CTC}+L_{RNN-T} being reduced, and
wherein L is the final loss value, L_{CTC} is a CTC loss value, and L_{RNN-T} is a transducer loss value.

19. The non-transitory computer readable medium of claim 17,
wherein the speech recognition model comprises an attention-based encoder-decoder (AED) model,
wherein the first loss value is a connectionist temporal classification (CTC) loss value and the second loss value is a cross-entropy (CE) loss value,
wherein the training further comprises training the speech recognition model in a manner that results in a final loss value obtained by an equation L=L_{CTC}+L_{CE} being reduced, and
wherein L is the final loss value, L_{CTC} is a CTC loss value, and L_{CE} is a CE loss value.

20. The non-transitory computer readable medium of claim 16, wherein the method further comprises:
based on the first speech sequence comprising the EOS label being input to the trained speech recognition model, obtaining a second speech sequence by changing the EOS label to a preset first symbol;
obtaining a text sequence by inputting the second speech sequence into the trained speech recognition model;
based on the EOS label being detected from the obtained text sequence, identifying whether a token comprising a preset second symbol is output during a threshold time; and
based on the token comprising the second symbol being output during the threshold time, outputting the obtained text sequence by recognizing the detected EOS label.
